(19) United States
(12) Patent Application Publication
(10) Pub. No.: US 2026/0169496 A1
(43) Pub. Date: Jun. 18, 2026

(54) METHOD AND APPARATUS FOR CONTROLLING AUTONOMOUS MOVING DEVICE, MEDIUM AND AUTONOMOUS MOVING DEVICE

(71) Applicant: Beijing Roborock Innovation Technology Co., Ltd., Beijing (CN)

(72) Inventors: Lei ZHANG, Beijing (CN); Xin GUAN, Beijing (CN); Yiming CONG, Beijing (CN); Jianqiang SHAN, Beijing (CN)

(73) Assignee: Beijing Roborock Innovation Technology Co., Ltd., Beijing (CN)

(21) Appl. No.: 19/531,291

(22) Filed: Feb. 5, 2026

Related U.S. Application Data
(63) Continuation of application No. PCT/CN2024/118048, filed on Sep. 10, 2024.

(51) Int. Cl. G05D 1/648; G05D 1/246; G05D 1/628; G05D 105/10; G05D 109/10

(52) U.S. Cl. CPC G05D 1/648; G05D 1/246; G05D 1/628; G05D 2105/10; G05D 2109/10

(57) ABSTRACT

The present application provides a method and apparatus for controlling an autonomous moving device, a medium and the autonomous moving device, wherein the method includes: receiving a setting instruction, provided by a user, for a cleaning and obstacle avoidance mode and/or cleaning and obstacle avoidance parameter; determining a corresponding collision probability and/or missed cleaning probability based on the setting instruction; and executing cleaning on a target region based on the collision probability and/or missed cleaning probability.

### CROSS REFERENCE TO RELATED APPLICATION

This application is a Continuation Application of International Application No. PCT/CN2024/118048, filed on Sep. 10, 2024, which claims priority to Chinese Patent Application No. 202311102977.X filed on Aug. 29, 2023, the disclosure of which is herein incorporated by reference in its entirety as part of the present application.

### TECHNICAL FIELD

The present application relates to the technical field of autonomous moving devices, and in particular to a method and apparatus for controlling an autonomous moving device, a medium and the autonomous moving device.

### BACKGROUND

With the development of technologies for autonomous moving devices, such devices have been widely used in the daily life of people.

### SUMMARY

In a first aspect, the present application provides a method for controlling an autonomous moving device, including:
receiving a setting instruction, provided by a user via a front-end application, for a cleaning and obstacle avoidance mode and/or cleaning and obstacle avoidance parameter;
determining a corresponding collision probability and/or missed cleaning probability based on the setting instruction; and
executing cleaning on a target region based on the collision probability and/or missed cleaning probability.

In a second aspect, an apparatus for controlling an autonomous moving device is provided according to the embodiments of the present application. The apparatus includes:
a receiving unit configured to receive a setting instruction, provided by a user via a front-end application, for a cleaning and obstacle avoidance mode and/or cleaning and obstacle avoidance parameter;
a probability hitting unit configured to determine a corresponding collision probability and/or missed cleaning probability based on the setting instruction; and
an executing unit configured to execute cleaning on a target region based on the collision probability and/or missed cleaning probability.

In a third aspect, a method for controlling an autonomous moving device is further provided by the embodiments of the present application. The method includes:
reading a historical cleaning log generated when the autonomous moving device performs cleaning on at least part of a target region; and
automatically adjusting a cleaning and obstacle avoidance mode and/or a cleaning and obstacle avoidance parameter of the autonomous moving device based on the historical cleaning log, wherein the cleaning and obstacle avoidance mode and/or cleaning and obstacle avoidance parameter are default or determined based on a setting instruction from a user.

In a fourth aspect, an apparatus for controlling an autonomous moving device is further provided according to the embodiments of the present application. The apparatus includes:
a reading unit configured to read a historical cleaning log generated when the autonomous moving device performs cleaning on at least part of a target region; and
an adjusting unit configured to automatically adjust a cleaning and obstacle avoidance mode and/or a cleaning and obstacle avoidance parameter of the autonomous moving device based on the historical cleaning log, wherein the cleaning and obstacle avoidance mode and/or cleaning and obstacle avoidance parameter are default or determined based on a setting instruction from a user.

In a fifth aspect, a computer-readable storage medium storing a computer program instruction therein is further provided according to the embodiments of the present application, wherein the computer program instruction is loaded and executed by a processor to implement operations performed in the method described above.

In a sixth aspect, an autonomous moving device is further provided according to the embodiments of the present application. The autonomous moving device includes a processor and a memory storing a computer program instruction executable by the processor, wherein the processor, when executing the computer program instruction, implements the method described above.

### BRIEF DESCRIPTION OF DRAWINGS

The accompanying drawings illustrated herein and forming part of the present application are used to provide further understanding of the present application, and the schematic embodiments and descriptions thereof in the present application are used to explain the present application, and are not intended to improperly limit the present application. In these drawings:

FIG. 1 shows a schematic flowchart of a method for controlling an autonomous moving device according to a first embodiment of the present application;

FIG. 2 shows a schematic flowchart of a method for controlling an autonomous moving device according to a second embodiment of the present application;

FIG. 3 shows a schematic structural diagram of an apparatus for controlling an autonomous moving device according to a third embodiment of the present application; and

FIG. 4 shows a schematic structural diagram of an apparatus for controlling an autonomous moving device according to a fourth embodiment of the present application.

### DETAILED DESCRIPTION

To make the objectives, technical solutions, and advantages of the present application clearer, the technical solutions of the present application will be clearly and completely described below in conjunction with the specific embodiments of the present application and the corresponding accompanying drawings. Obviously, the described embodiments are only part of rather than all of the embodiments of the present application. All other embodiments acquired by a person of ordinary skill in the art based on the embodiments in the present application without creative work shall fall within the protection scope of the present application.

The technical solution provided by each embodiment of the present application will be explained in detail below with reference to the accompanying drawings.

Autonomous moving devices, also known as automatic cleaners, sweeper robots, smart vacuum cleaners, sweeper cleaners, sweepers, etc., are a class of smart household appliances that can automatically complete floor cleaning in a room by virtue of certain artificial intelligence. The autonomous moving devices generally collect debris on the ground into their own garbage storage boxes at first by means of sweeping and vacuuming, thereby fulfilling the function of cleaning the ground. In general, sweepers that complete cleaning, vacuuming, and mopping are also classified as the autonomous moving devices.

In the prior art, once turned on by a user, the autonomous moving device cleans a target region following a preset strategy. This preset strategy is usually unchanged and thus cannot meet some of the differentiated needs of the user. For example, for a room that is not dirty, the user may only want to clean it quickly. However, the autonomous moving device still conducts cleaning following its established mode, which typically requires more time and effort.

However, existing autonomous moving devices typically execute cleaning according to preset designated programs, which, however, cannot meet the diverse needs of users, for example, a user seeking to clean a room quickly and easily. In view of the above situation, embodiments of the present application provide a method and apparatus for controlling an autonomous moving device, a medium, and the autonomous moving device, in order to overcome or at least partially overcome the shortcomings of the prior art.

In view of the above-mentioned defects of the existing autonomous moving devices, the present application is proposed, which is based on the following concept: a front-end application of an autonomous mobile device displays configurable options for a cleaning and obstacle avoidance mode and/or cleaning and obstacle avoidance parameter; a user is allowed to properly set the cleaning and obstacle avoidance mode and/or cleaning and obstacle avoidance parameter via a front-end application; a corresponding collision probability and/or missed cleaning probability are/is determined based on the cleaning and obstacle avoidance mode and/or cleaning and obstacle avoidance parameter set by the user; and cleaning is executed on a target region based on this collision probability and/or missed cleaning probability. In this way, a variety of personalized and differentiated needs of the user are met.

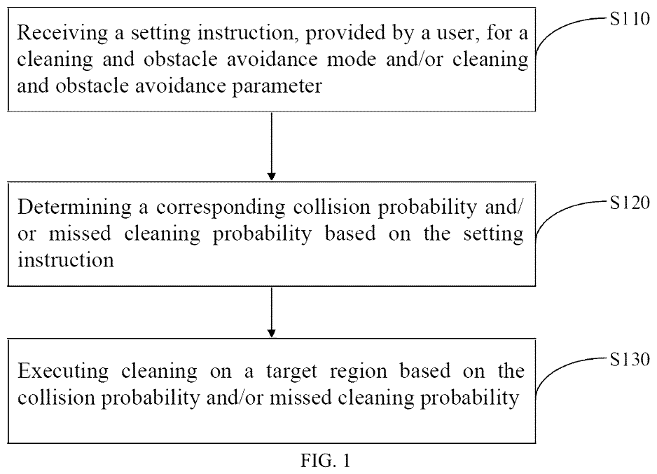

FIG. 1 shows a schematic flowchart of a method for controlling an autonomous moving device according to a first embodiment of the present application. As can be seen from FIG. 1, the first embodiment includes at least steps S110 to S130.

In step S110, a setting instruction, provided by a user, for a cleaning and obstacle avoidance mode and/or cleaning and obstacle avoidance parameter is received.

In some embodiments, the autonomous moving device itself has a display screen, virtual buttons or physical buttons. On the display screen, the autonomous moving device can display options for a cleaning and obstacle avoidance mode and/or cleaning and obstacle avoidance parameter for the user to set. If the user does not make settings, the device may adopt a default mode.

In other embodiments, the autonomous moving device, as a smart device, is usually communicatively connected to the front-end application, and the user may control the autonomous moving device via the front-end application. That is, the front-end application displays options for the cleaning and obstacle avoidance mode and/or cleaning and obstacle avoidance parameter for the user to set.

In the present application, a plurality of configuration methods are provided. For example, in some embodiments, some control parameters are abstracted into different cleaning and obstacle avoidance modes. The user only needs to specify a certain level of cleaning and obstacle avoidance mode, and the autonomous moving device will clean a target region in this mode. For example, in some embodiments, the cleaning and obstacle avoidance modes include, but are not limited to: a cautious obstacle avoidance mode and a tolerant obstacle avoidance mode. More levels of cleaning and obstacle avoidance modes may be set as required, which is not limited in the present application.

In other embodiments, the cleaning and obstacle avoidance parameter may be directly displayed. The cleaning and obstacle avoidance parameter includes but is not limited to at least one of: a wall-following collision level parameter, an obstacle-avoidance collision level parameter, and/or a dense-obstacle region collision level parameter. Here, the wall-following collision level parameter includes a wall-edge collision level parameter and a head-on wall collision level parameter. Here, the wall-following collision level parameter represents the probability of collision of the autonomous moving device along a wall, and mainly refers to the possibility of collision against a wall edge and the possibility of collision against a head-on wall. The obstacle avoidance collision level parameter represents the possibility of collision with low-lying obstacles, such as shoes, slippers and weight scales. The dense-obstacle region collision level parameter represents the possibility of collision with table-and-chair arrangements, sofa-and-coffee-table areas, etc.

In some embodiments, in order to facilitate user operations, the cleaning and obstacle avoidance parameter may be configured in the form of levels. The user only needs to specify a level, instead of filling in a specific parameter. Each of the wall-along collision level parameter, the obstacle-avoidance collision level parameter, and the dense-obstacle region collision level parameter may be set to multiple levels to meet different needs of the user.

Compared with a one-click setting method for modes, this method is slightly more cumbersome, but more suitable for some special scenes. In a target region where regions along walls are dirtier while an open central region remains relatively clean, the wall-following collision level parameter may be set relatively strictly, and the obstacle-avoidance collision level parameter may be set with a relatively tolerant point cloud, such that the autonomous moving device spends more time cleaning along the wall, but with a tolerant obstacle avoidance requirement for the open central region, thereby achieving easy cleaning.

In other embodiments, the cleaning and obstacle avoidance modes and the cleaning and obstacle avoidance parameters may be combined. For example, the user is not only allowed to set different levels of cleaning and obstacle avoidance modes, but also allowed to set some parameters of a set cleaning and obstacle avoidance mode. This may meet the differentiated needs of the user while facilitating user operations. For example, the user may set a tolerant dense-obstacle region collision level parameter in the cautious obstacle avoidance mode. This achieves strict cleaning over large regions while allowing the device to bypass narrow spaces between a plurality of obstacles, thereby reducing cleaning time and improving cleaning efficiency. Moreover, the simultaneous setting of modes and parameters significantly facilitate user operations.

In step S120, a corresponding collision probability and/or missed cleaning probability are/is determined based on the setting instruction.

The actual meanings of the cleaning and obstacle avoidance mode and/or cleaning and obstacle avoidance parameter may be understood as the probabilities desired by the user that the autonomous moving device will collide with an obstacle in practice and miss the cleaning of a narrow space, and these probabilities are denoted as the collision probability and the missed cleaning probability, respectively.

A corresponding relationship is established between the cleaning and obstacle avoidance mode and/or cleaning and obstacle avoidance parameter and the collision probability and/or missed cleaning probability in advance. This corresponding relationship can be simply understood as a mapping relationship. That is, a cleaning and obstacle avoidance mode and/or cleaning and obstacle avoidance parameter correspond(s) to a certain collision probability or a missed scanning probability, or both. In practice, taking the cleaning and obstacle avoidance mode as an example, the values of a plurality of parameters of the cleaning and obstacle avoidance mode are converted into the collision probability and/or missed scanning probability according to an algorithm.

After the user sets the cleaning and obstacle avoidance mode and/or cleaning and obstacle avoidance parameter, the corresponding collision probability and/or missed scanning probability can be hit based on the aforementioned mapping relationship.

Therefore, different strict levels of the collision probabilities and/or missed scanning probabilities of can be achieved by setting different levels of the cleaning and obstacle avoidance modes and/or cleaning and obstacle avoidance parameters. As described previously, when the cleaning and obstacle avoidance modes are configured to include the cautious obstacle avoidance mode and the tolerant obstacle avoidance mode, the cautious obstacle avoidance mode may be configured to correspond to a lower collision probability and a higher missed cleaning probability as compared to the tolerant obstacle avoidance mode. In addition, the cautious obstacle avoidance mode and the tolerant obstacle avoidance mode may also be configured to include multiple obstacle avoidance levels, such as obstacle avoidance levels 1-10. The higher the level, the lower the corresponding collision probability and/or the higher the corresponding missed cleaning probability. The user may choose a specific level from the cautious obstacle avoidance mode or the tolerant obstacle avoidance mode.

In step S130, cleaning is executed on a target region based on the collision probability and/or missed cleaning probability.

A certain value of the collision probability and/or missed scanning probability corresponds to a certain cleaning strategy. The so-called cleaning strategy refers to the way for the autonomous moving device to handle obstacles such as corners and sofas; and the cleaning strategy is usually presented in the form of parameters.

Specifically, in some embodiments of the present application, executing cleaning on the target region based on the collision probability and/or missed cleaning probability includes: determining a corresponding cleaning parameter based on the collision probability and/or missed cleaning probability, the cleaning parameter including at least one of: a wall-following distance, a wall-following turning amplitude, a wall-following forward travel distance, and/or a post-turning distance from an opposite wall, wherein a lower collision probability and/or a higher missed cleaning probability correspond(s) to a longer wall-following distance, a greater turning amplitude, a longer wall-following forward travel distance, and a longer post-turning distance from the opposite wall; and cleaning the target region based on the cleaning parameter.

The cleaning parameter includes but is not limited to at least one of: a wall-following distance, a wall-following turning amplitude, a wall-following forward travel distance, and/or a post-turning distance from an opposite wall. These parameters are mainly related to the autonomous moving device when it moves along a wall. Here, the wall-following distance may be understood as the distance maintained, by means of a wall-following sensor, between the autonomous moving device and the wall during wall-following operations. The wall-following turning amplitude may be understood as the range of turning executed by the autonomous moving device during wall-following operations. The wall-following forward travel distance may be understood as the distance traveled forward after a turn is completed. The post-turning distance from an opposite wall may be understood as the distance from the opposite wall after a turn is completed.

When configuring a cleaning strategy, a lower collision probability and a higher missed cleaning probability correspond to a longer wall-following distance, a greater turning amplitude, a longer wall-following forward travel distance, and a longer post-turning distance from the opposite wall. The lower collision probability and the higher missed cleaning probability may be understood as the stricter implementation of minimizing collision and more tolerant acceptance of missed cleaning in some regions. It may be simply understood that: for the settings made for the collision level of the autonomous moving device during wall-following operations, the lower the collision probability, the greater the wall-following distance, and at the same time, the larger the wall-following turning amplitude, the longer the wall-following forward travel distance, and the larger the post-turning distance from the opposite wall.

For example, when the collision probability is 20% and the missed cleaning probability is 5%, the mapped wall-following distance is 0.7 cm, the wall-following turning amplitude is 2 cm, the wall-following forward travel distance is 1.5 cm, and the post-turning distance from the opposite wall is 1 cm. Then, the target region is cleaned autonomously based on the cleaning parameter. The above data are provided merely for illustrative purposes and do not constitute any limitation to the present application.

In some embodiments of the present application, executing cleaning on the target region based on the collision probability and/or missed cleaning probability includes: determining a corresponding cleaning parameter based on the collision probability and/or missed cleaning probability, the cleaning parameter including at least one of: an obstacle avoidance range and/or a number of point clouds within the obstacle avoidance range, wherein a lower collision probability and a higher missed cleaning probability correspond to a larger obstacle avoidance range and a smaller number of point clouds within the obstacle avoidance range; and cleaning the target region based on the cleaning parameter.

In some embodiments, the cleaning parameter includes but is not limited to at least one of: an obstacle avoidance range and/or the number of point clouds within the obstacle avoidance range. Here, the obstacle avoidance range may be understood as the obstacle avoidance range created by using the LDS (Laser Distance Sensor) technology during movement of the autonomous moving device. LDS is a laser distance sensor that is commonly used for obstacle avoidance functions in robots, smart homes and other equipment. The obstacle avoidance range of LDS is closely related to its design parameters. In general, the distance range within which LDS technology may detect and avoid obstacles in front is usually between a few meters and more than ten meters. The number of point clouds within the obstacle avoidance range refers to the number of point clouds collected within that obstacle avoidance range.

A lower collision probability and a higher missed cleaning probability correspond to a larger obstacle avoidance range and a smaller number of point clouds within the obstacle avoidance range. This can be understood as follows: for collision scenes involving obstacle avoidance of the autonomous moving device, setting a lower collision probability (i.e., the stricter the collision minimization capability) results in a larger LDS obstacle avoidance range. That is, obstacle avoidance begins at a greater distance from the obstacle, and fewer LDS points (point clouds) are required within the obstacle avoidance range.

Based on the collision probability and/or missed cleaning probability, the obstacle avoidance range and the number of point clouds within the obstacle avoidance range are determined, and then, the target region may be cleaned based on the cleaning parameter.

In some embodiments of the present application, executing cleaning on the target region based on the collision probability and/or missed cleaning probability includes: determining a corresponding cleaning parameter based on the collision probability and/or missed cleaning probability, the cleaning parameter including at least one of: a number of point clouds in a dense region, a size of an accessible space, a priority of passing through a dense region, and/or a cleaning coverage of dense regions, wherein a lower collision probability and a higher missed cleaning probability correspond to a smaller number of point clouds in a dense region, a larger size of the accessible space, a lower priority of passing through a dense region, and a smaller cleaning coverage of dense regions; and cleaning the target region based on the cleaning parameter.

In some embodiments, the cleaning parameter includes at least one of: the number of point clouds in a dense region, the size of an accessible space, the priority of passing through a dense region, and/or the cleaning coverage of dense regions. The parameter is set for the autonomous moving device to clean the dense-obstacle region. Here, the number of point clouds in a dense region can be understood as the minimum number of LDS points collected for a dense region; the size of an accessible space can be understood as the size of a narrow space between a plurality of obstacles, into which the autonomous moving device may autonomously enter; the priority of passing through a dense region indicates whether to prioritize passing through a dense region; and the cleaning coverage of dense regions maybe understood as the proportion of cleaned dense regions in the total dense regions.

A lower collision probability and a higher missed cleaning probability correspond to a smaller number of point clouds in a dense region, a larger size of the accessible space, a lower priority of passing through a dense region, and a smaller cleaning coverage of dense regions. That is, the stricter collision minimization capability, the fewer the points required within the LDS obstacle avoidance range in dense regions, the larger the accessible narrow space between a plurality of obstacles for the autonomous moving device, the higher the priority to avoid passing through a dense region, and the smaller the cleaning coverage in dense regions.

Based on the collision probability and/or missed cleaning probability, the number of point clouds in a dense region, the size of an accessible space, the priority of passing through a dense region, and the cleaning coverage of dense regions are determined, and then, the target region may be cleaned based on the cleaning parameter.

In addition, in some embodiments of the present embodiments, the method further includes: intelligently identifying a current scene of the target region, and matching the corresponding cleaning parameter based on a scene identification result and in combination with the collision probability and/or missed cleaning probability, to execute cleaning on the target region.

The present application also allows for employing different cleaning strategies across different scenes. Taking the cleaning and obstacle avoidance mode as an example, the cleaning and obstacle avoidance mode at the same level in different scenes correspond to different values of the collision probability and the missed cleaning probability, so as to meet different requirements of these scenes. Refer to Table 1.

TABLE 1

| Cleaning and obstacle | | Collision | Missed cleaning |
|---|---|---|---|
| avoidance mode | Scene | probability | probability |
| Cautious obstacle | Scene 1 | a1% | b1% |
| avoidance mode | | | |
| Cautious obstacle | Scene 2 | a2% | b2% |
| avoidance mode | | | |

As can be seen from Table 1, under the same cautious obstacle avoidance mode, for the scene 1, the collision probability is configured as a1% and the missed cleaning probability is configured as b1%; and for the scene 2, the collision probability is configured as a2% and the missed cleaning probability is configured as b2%. In this way, when cleaning tasks are executed based on the collision probability and the missed-scan probability, different cleaning strategies can be matched to different collision and missed-scan probabilities, thereby meeting the requirements of different scenes.

In some embodiments of the present embodiments, before cleaning is executed on the target region based on the collision probability and/or missed cleaning probability, the method further includes at least one of: receiving a designation instruction, provided by the user based on a pre-built map, for the target region; and/or determining, by means of intelligent identification, whether the autonomous moving device enters the target region, and if so, determining to execute the step of executing cleaning on the target region based on the collision probability and/or missed cleaning probability.

In some embodiments of the present application, the target region may be in the overall map or in part of the map. An original map is usually built in advance and pre-stored in the autonomous moving device.

The user may designate a region as the target region on the saved map, and set the cleaning and obstacle avoidance mode and/or cleaning and obstacle avoidance parameter for the target region. The autonomous moving device may identify a current region, and when determining to enter the target region designated by the user, the autonomous moving device executes cleaning on the target region based on the collision probability and/or missed scanning probability mapped to the cleaning and obstacle avoidance mode and/or cleaning and obstacle avoidance parameter as designated by the user.

In some embodiments of the present embodiments, the method further includes: reading a historical cleaning log of at least part of the target region; and automatically adjusting the cleaning and obstacle avoidance mode and/or cleaning and obstacle avoidance parameter based on the historical cleaning log.

The present application also allows for adaptive adjustment of the cleaning and obstacle avoidance mode and/or cleaning and obstacle avoidance parameter. Specifically, automatic adjustment may be performed based on the historical cleaning log of the autonomous moving device.

Specifically, in response to determining based on the historical cleaning log that a number of collisions with any obstacle is greater than a preset first threshold, the cleaning obstacle avoidance mode and/or cleaning obstacle avoidance parameter are/is adjusted to achieve a lower collision probability.

For example, if the autonomous moving device repeatedly collides with an obstacle within a target region over a historical period, and when the number of collisions exceeds a threshold (e.g., 10), the cleaning and obstacle avoidance mode and/or cleaning and obstacle avoidance parameter are/is adjusted to a stricter level, i.e., to further reduce a collision probability, thereby minimizing future collisions with that obstacle in this region.

In some embodiments of the present embodiments, the method further includes: in response to a current collision probability being less than a preset second threshold, not executing the step of adjusting the cleaning and obstacle avoidance mode and/or cleaning and obstacle avoidance parameter.

That is to say, when the collision probability achieved by the autonomous moving device in a region by means of the cleaning and obstacle avoidance mode and/or cleaning and obstacle avoidance parameter is more tolerant than a threshold, it indicates that a current collision mode is already quite tolerant, and the cleaning and obstacle avoidance mode and/or cleaning and obstacle avoidance parameter will not be adjusted.

As can be seen from FIG. 1, according to the present application, the user is allowed to set the cleaning and obstacle avoidance mode and/or cleaning and obstacle avoidance parameter of the autonomous moving device via the front-end application; the corresponding collision probability and/or missed cleaning probability are/is determined based on the cleaning and obstacle avoiding mode and/or cleaning and obstacle avoiding parameter set by the user; and cleaning is executed on the target region based on the collision probability and/or missed cleaning probability. In this way, a variety of personalized and differentiated needs of the user are met, to achieve precise fulfillment of the user requirements of avoiding collisions in certain regions and preventing missed cleaning in certain regions to the greatest extent, such that with guaranteed cleaning quality, the cleaning time is significantly reduced, and the utilization rate of the autonomous moving device is improved, and simple algorithm and high practicability are achieved.

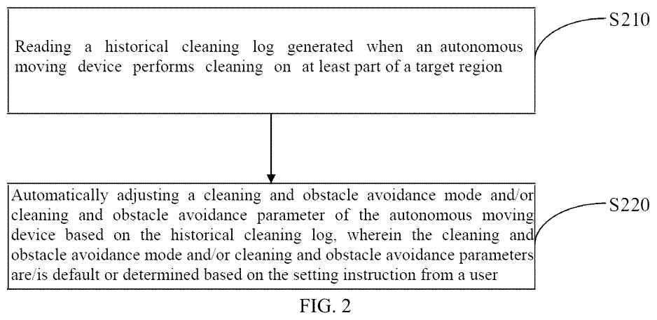

FIG. 2 shows a schematic flowchart of a method for controlling an autonomous moving device according to a second embodiment of the present application. As can be seen from FIG. 2, the second embodiment includes at least steps S210 to S220.

In step S210, a historical cleaning log generated when the autonomous moving device performs cleaning on at least part of a target region is read.

As described previously, the present application provides an autonomous moving device with a configurable cleaning and obstacle avoidance mode and/or cleaning and obstacle avoidance parameter. Specifically, in some embodiments, the autonomous moving device itself has a display screen, virtual buttons or physical buttons. On the display screen, the autonomous moving device may display options for the cleaning and obstacle avoidance mode and/or cleaning and obstacle avoidance parameter for the user to set. If the user does not make settings, the device may adopt a default mode. In other embodiments, the autonomous moving device, as a smart device, is usually communicatively connected to the front-end application, and the user may control the autonomous moving device via the front-end application. That is, the front-end application displays options for the cleaning and obstacle avoidance mode and/or cleaning and obstacle avoidance parameter for the user to set.

In the present application, a plurality of configuration methods are provided. For example, in some embodiments, some control parameters are abstracted into different cleaning and obstacle avoidance modes. The user only needs to specify a certain level of cleaning and obstacle avoidance mode, and the autonomous moving device will clean a target region in this mode. For example, in some embodiments, the cleaning and obstacle avoidance mode includes, but is not limited to: a cautious obstacle avoidance mode and a tolerant obstacle avoidance mode. More levels of cleaning and obstacle avoidance modes may be set as required, which is not limited in the present application.

In other embodiments, the cleaning and obstacle avoidance parameter may be directly displayed. The cleaning and obstacle avoidance parameter includes but is not limited to at least one of: a wall-following collision level parameter, an obstacle-avoidance collision level parameter, and/or a dense-obstacle region collision level parameter. Here, the wall-following collision level parameter includes a wall-edge collision level parameter and a head-on wall collision level parameter. Here, the wall-following collision level parameter represents the probability of collision of the autonomous moving device along a wall, and mainly refers to the possibility of collision against a wall edge and the possibility of collision against a head-on wall. The obstacle avoidance collision level parameter represents the possibility of collision with low-lying obstacles, such as shoes, slippers and weight scales. The dense-obstacle region collision level parameter represents the possibility of collision with table-and-chair arrangements, sofa-and-coffee-table areas, etc.

In some embodiments, in order to facilitate user operations, the cleaning and obstacle avoidance parameter may be configured in the form of levels. The user only needs to specify a level, instead of filling in a specific parameter. Each of the wall-along collision level parameter, the obstacle-avoidance collision level parameter, and the dense-obstacle region collision level parameter may be set to multiple levels to meet different needs of the user.

Compared with a one-click setting method for modes, this method is slightly more cumbersome, but more suitable for some special scenes. In a target region where regions along walls are dirtier while an open central region remains relatively clean, the wall-following collision level parameter may be set relatively strictly, and the obstacle-avoidance collision level parameter may be set with a relatively tolerant point cloud, such that the autonomous moving device spends more time cleaning along the wall, but with a tolerant obstacle avoidance requirement for the open central region, thereby achieving easy cleaning.

In other embodiments, the cleaning and obstacle avoidance mode and the cleaning and obstacle avoidance parameter may be combined. For example, the user is not only allowed to set different levels of cleaning and obstacle avoidance modes, but also allowed to set some parameters of a set cleaning and obstacle avoidance mode. This may meets the differentiated needs of the user while facilitating user operations. For example, the user may set a tolerant dense-obstacle region collision level parameter in the cautious obstacle avoidance mode. This achieves strict cleaning over large regions while allowing the device to bypass narrow spaces between a plurality of obstacles, thereby reducing cleaning time and improving cleaning efficiency. Moreover, the simultaneous setting of modes and parameters significantly facilitate user operations.

In step S220, the cleaning and obstacle avoidance mode and/or cleaning and obstacle avoidance parameter of the autonomous moving device are/is automatically adjusted based on the historical cleaning log, wherein the cleaning and obstacle avoidance mode and/or cleaning and obstacle avoidance parameter are/is default or determined based on the setting instruction from the user.

In addition to allowing the user to manually adjust the cleaning and obstacle avoidance mode and/or cleaning and obstacle avoidance parameter, the present application also allows for automatic adjustment of the cleaning and obstacle avoidance mode and/or cleaning and obstacle avoidance parameter. Specifically, a log generated when the autonomous moving device cleans a region over a historical period of time is obtained and denoted as a historical cleaning log, and then the cleaning and obstacle avoidance mode and/or cleaning and obstacle avoidance parameter are/is adaptively adjusted based on the historical cleaning log.

Specifically, in some embodiments of the present embodiments, automatically adjusting the cleaning and obstacle avoidance mode and/or cleaning and obstacle avoidance parameter based on the historical cleaning log includes: in response to determining based on the historical cleaning log that a number of collisions with any obstacle is greater than a preset first threshold, adjusting the cleaning obstacle avoidance mode and/or cleaning obstacle avoidance parameter to achieve a lower collision probability.

For example, if the autonomous moving device repeatedly collides with an obstacle within a target region over a historical period, and when the number of collisions exceeds a threshold (e.g., 10), the cleaning and obstacle avoidance mode and/or cleaning and obstacle avoidance parameter are/is adjusted to a stricter level, i.e., to further reduce a collision probability, thereby minimizing future collisions with that obstacle in this region.

In other embodiments, the method further includes: in response to a current collision probability being less than a preset second threshold, not executing the step of adjusting the cleaning and obstacle avoidance mode and/or cleaning and obstacle avoidance parameter of the autonomous moving device.

That is to say, when the collision probability achieved by the autonomous moving device in a region by means of the cleaning and obstacle avoidance mode and/or cleaning and obstacle avoidance parameter is more tolerant than a threshold, it indicates that a current collision mode is already quite tolerant, and the cleaning and obstacle avoidance mode and/or cleaning and obstacle avoidance parameter will not be adjusted.

As can be seen from the method shown in FIG. 2, the present application allows for adaptive adjustment of the cleaning and obstacle avoidance mode and/or cleaning and obstacle avoidance mode of the autonomous moving device. This not only eliminates the need for user operations, but also meets a variety of personalized and differentiated needs of users, achieving precise fulfillment of the user requirements of avoiding collisions in certain regions and preventing missed cleaning in certain regions to the greatest extent. In this way, with guaranteed cleaning quality, the cleaning time is significantly reduced, the utilization rate of the autonomous moving device is improved, and simple algorithm and high practicability are achieved.

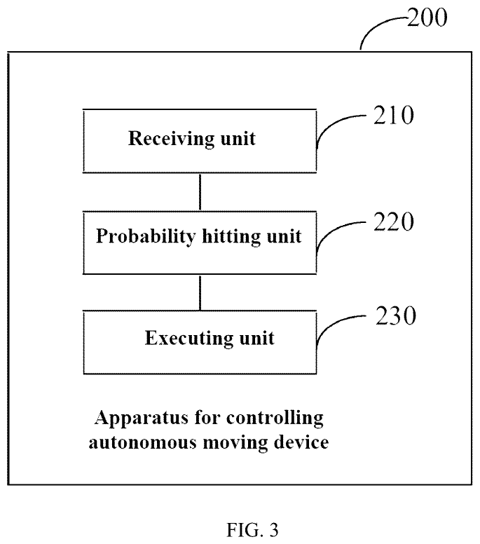

FIG. 3 shows a schematic structural diagram of an apparatus for controlling an autonomous moving device according to a third embodiment of the present application. As can be seen from FIG. 3, the apparatus 200 for controlling the autonomous moving device includes:
a receiving unit 210 configured to receive a setting instruction, provided by a user via a front-end application, for a cleaning and obstacle avoidance mode and/or cleaning and obstacle avoidance parameter;
a probability hitting unit 220 configured to determine a corresponding collision probability and/or missed cleaning probability based on the setting instruction; and
an executing unit 230 configured to execute cleaning on a target region based on the collision probability and/or missed cleaning probability.

In some embodiments of the present application, in the above-mentioned apparatus, the cleaning and obstacle avoidance parameter includes at least one of: a wall-following collision level parameter, an obstacle-avoidance collision level parameter, and/or a dense-obstacle region collision level parameter.

In some embodiments of the present application, in the above-mentioned apparatus, the wall-following collision level parameter includes a wall-edge collision level parameter and a head-on wall collision level parameter.

In some embodiments of the present application, in the above-mentioned apparatus, the cleaning and obstacle avoidance mode includes: a cautious obstacle avoidance mode and a tolerant obstacle avoidance mode, and the cautious obstacle avoidance mode corresponds to a lower collision probability and a higher missed cleaning probability as compared to the tolerant obstacle avoidance mode.

In some embodiments of the present application, in the above-mentioned apparatus, the cautious obstacle avoidance mode and the tolerant obstacle avoidance mode each include multiple obstacle avoidance levels.

In some embodiments of the present application, in the above-mentioned apparatus, the executing unit 230 is further configured to: determine a corresponding cleaning parameter based on the collision probability and the missed cleaning probability, the cleaning parameter including at least one of: a wall-following distance, a wall-following turning amplitude, a wall-following forward travel distance, and/or a post-turning distance from an opposite wall, wherein a lower collision probability and a higher missed cleaning probability correspond to a longer wall-following distance, a greater turning amplitude, a longer wall-following forward travel distance, and a longer post-turning distance from the opposite wall; and clean the target region based on the cleaning parameter.

In some embodiments of the present application, in the above-mentioned apparatus, the executing unit 230 is further configured to: determine a corresponding cleaning parameter based on the collision probability and/or missed cleaning probability, the cleaning parameter including at least one of: an obstacle avoidance range and/or a number of point clouds within the obstacle avoidance range, wherein a lower collision probability and a higher missed cleaning probability correspond to a larger obstacle avoidance range and a smaller number of point clouds within the obstacle avoidance range; and clean the target region based on the cleaning parameter.

In some embodiments of the present application, in the above-mentioned apparatus, the executing unit 230 is further configured to: determine a corresponding cleaning parameter based on the collision probability and/or missed cleaning probability, the cleaning parameter including at least one of: a number of point clouds in a dense region, a size of an accessible space, a priority of passing through a dense region, and/or a cleaning coverage of dense regions, wherein a lower collision probability and a higher missed cleaning probability correspond to a smaller number of point clouds in a dense region, a larger size of the accessible space, a lower priority of passing through a dense region, and a smaller cleaning coverage of dense regions; and clean the target region based on the cleaning parameter.

In some embodiments of the present application, in the above-mentioned apparatus, the executing unit 230 is further configured to: intelligently identify a current scene of the target region, and match the corresponding cleaning parameter based on a scene identification result and in combination with the collision probability and/or missed cleaning probability, to execute cleaning on the target region.

In some embodiments of the present embodiments, in the above-mentioned apparatus, the executing unit 230 is further configured to: receive a designation instruction, provided by the user based on a pre-built map, for the target region; and in response to determining the entry into the target region by means of intelligent identification, execute the step of executing cleaning on the target region based on the collision probability and/or missed cleaning probability.

In some embodiments of the present application, in the above-mentioned apparatus, the executing unit 230 is further configured to: read a historical cleaning log of at least part of the target region; and automatically adjust the cleaning and obstacle avoidance mode and/or cleaning and obstacle avoidance parameter based on the historical cleaning log.

In some embodiments of the present application, in the above-mentioned apparatus, the executing unit 230 is further configured to: in response to determining based on the historical cleaning log that a number of collisions with any obstacle is greater than a preset first threshold, adjust the cleaning obstacle avoidance mode and/or cleaning obstacle avoidance parameter to achieve a lower collision probability.

In some embodiments of the present application, in the above-mentioned apparatus, the executing unit 230 is further configured to: in response to a current collision probability being less than a preset second threshold, not execute the step of adjusting the cleaning and obstacle avoidance mode and/or cleaning and obstacle avoidance parameter.

It should be noted that the above-mentioned control apparatus 200 for the autonomous moving device may implement the aforementioned method for controlling the autonomous moving device shown in FIG. 1 respectively, and the same technical features as the method for controlling the autonomous moving device shown in FIG. 1 will not be repeated herein.

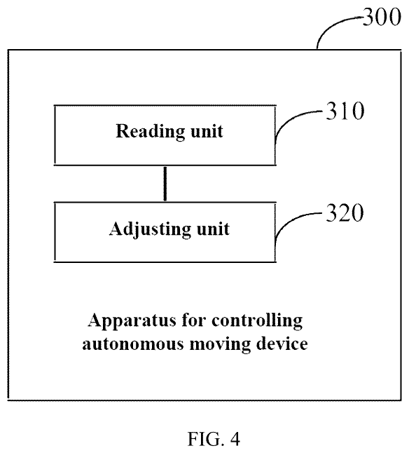

FIG. 4 shows a schematic structural diagram of an apparatus for controlling an autonomous moving device according to a fourth embodiment of the present application. As can be seen from FIG. 4, the apparatus 300 for controlling the autonomous moving device includes:
a reading unit 310 configured to read a historical cleaning log generated when the autonomous moving device performs cleaning on at least part of a target region; and
an adjusting unit 320 configured to automatically adjust the cleaning and obstacle avoidance mode and/or cleaning and obstacle avoidance parameter of the autonomous moving device based on the historical cleaning log, wherein the cleaning and obstacle avoidance mode and/or cleaning and obstacle avoidance parameter are default or determined based on the setting instruction from the user.

Optionally, in the above-mentioned apparatus, the adjusting unit 320 is further configured to: in response to determining based on the historical cleaning log that a number of collisions with any obstacle is greater than a preset first threshold, adjust the cleaning obstacle avoidance mode and/or cleaning obstacle avoidance parameter to achieve a lower collision probability.

Optionally, in the above-mentioned apparatus, the adjusting unit 320 is further configured to: in response to a current collision probability being less than a preset second threshold, not executing the step of adjusting the cleaning and obstacle avoidance mode and/or cleaning and obstacle avoidance parameter.

It should be noted that the above-mentioned control apparatus 300 for the autonomous moving device may implement the aforementioned method for controlling the autonomous moving device shown in FIG. 2 respectively, and the same technical features as the method for controlling the autonomous moving device shown in FIG. 2 will not be repeated herein. A computer-readable storage medium storing a computer program instruction therein is provided according to a fifth embodiment of the present application, wherein the computer program instruction is loaded and executed by a processor to implement operations performed in the method as described in the first embodiment above.

An autonomous moving device is provided according to a sixth embodiment of the present application. The autonomous moving device includes a processor and a memory storing a computer program instruction executable by the processor, wherein the processor, when executing the computer program instruction, implements the method as described above. The apparatus described above corresponds to the method embodiment and has the same technical effect as the method embodiment. A reference may be made to the method embodiment for detailed description.

The apparatus embodiment is achieved based on the method embodiment. A reference may be made to the method embodiment section for detailed description, which will not be repeated herein.

Persons of ordinary skill in the art can understand that each accompanying drawing is only the schematic diagram of one embodiment, and the modules or flow processes shown in the accompanying drawings are not necessarily essential for implementing the present application.

Persons of ordinary skill in the art can understand that the modules in the apparatus in the embodiment may be distributed in the apparatus in the embodiment according to the description of the embodiment, or may be correspondingly changed and positioned in one or more apparatuses different from said embodiment. The modules in the above embodiments may be combined into one module, or further divided into multiple sub-modules.

At least one of the above-mentioned technical solutions employed in the embodiments of the present application can achieve the following advantageous effects.

According to the present application, the user is allowed to set the cleaning and obstacle avoidance mode and/or cleaning and obstacle avoidance parameter of the autonomous moving device via the front-end application, the corresponding collision probability and/or missed cleaning probability are/is determined based on the cleaning and obstacle avoiding mode and/or cleaning and obstacle avoiding parameter set by the user; and cleaning is executed on the target region based on the collision probability and/or missed cleaning probability. In this way, a variety of personalized and differentiated needs of the user are met, to achieve precise fulfillment of the user requirements of avoiding collisions in certain regions and preventing missed cleaning in certain regions to the greatest extent, such that with guaranteed cleaning quality, the cleaning time is significantly reduced, the utilization rate of the autonomous moving device is improved, and simple algorithm and high practicability are achieved.

Finally, it should be noted that the above embodiments are only used to illustrate, instead of limiting, the technical solutions of the present application. Although the present application is described in detail with reference to the foregoing embodiments, it can be understood by persons of ordinary skill in the art that they can still make modifications to the technical solutions disclosed in the above embodiments or carry out equivalent substitutions on some of technical features. These modifications or substitutions do not depart the nature of the corresponding technical solutions from the spirit and scope of the technical solutions of the embodiments of the present application.

1. A method for controlling an autonomous moving device, comprising:
receiving a setting instruction, provided by a user, for at least one of a cleaning and obstacle avoidance mode or cleaning and obstacle avoidance parameter;
determining at least one of a corresponding collision probability or a corresponding missed cleaning probability based on the setting instruction; and
executing cleaning on a target region based on at least one of the collision probability or missed cleaning probability.

2. The method according to claim 1, wherein the cleaning and obstacle avoidance parameter comprises at least one of: a wall-following collision level parameter, an obstacle-avoidance collision level parameter, or a dense-obstacle region collision level parameter.

3. The method according to claim 2, wherein the wall-following collision level parameter comprises a wall-edge collision level parameter and a head-on wall collision level parameter.

4. The method according to claim 1, wherein the cleaning and obstacle avoidance mode comprises: a cautious obstacle avoidance mode and a tolerant obstacle avoidance mode, and the cautious obstacle avoidance mode corresponds to at least one of a lower collision probability or a higher missed cleaning probability as compared to the tolerant obstacle avoidance mode.

5. The method according to claim 4, wherein the cautious obstacle avoidance mode and the tolerant obstacle avoidance mode each comprise multiple obstacle avoidance levels.

6. The method according to claim 1, wherein executing cleaning on the target region based on at least one of the collision probability or missed cleaning probability comprises:
determining a corresponding cleaning parameter based on at least one of the collision probability or missed cleaning probability, the cleaning parameter comprising at least one of: a wall-following distance, a wall-following turning amplitude, a wall-following forward travel distance, or a post-turning distance from an opposite wall, wherein at least one of a lower collision probability or a higher missed cleaning probability corresponds to a longer wall-following distance, a greater turning amplitude, a longer wall-following forward travel distance, and a longer post-turning distance from the opposite wall; and
cleaning the target region based on the cleaning parameter.

7. The method according to claim 1, wherein executing cleaning on the target region based on at least one of the collision probability or missed cleaning probability comprises:
determining a corresponding cleaning parameter based on at least one of the collision probability or missed cleaning probability, the cleaning parameter comprising at least one of: an obstacle avoidance range or a number of point clouds within the obstacle avoidance range, wherein at least one of a lower collision probability or a higher missed cleaning probability corresponds to a larger obstacle avoidance range and a smaller number of point clouds within the obstacle avoidance range; and
cleaning the target region based on the cleaning parameter.

8. The method according to claim 1, wherein executing cleaning on the target region based on at least one of the collision probability or missed cleaning probability comprises:
determining a corresponding cleaning parameter based on at least one of the collision probability or missed cleaning probability, the cleaning parameter comprising at least one of: a number of point clouds in a dense region, a size of an accessible space, a priority of passing through a dense region, or a cleaning coverage of dense regions, wherein at least one of a lower collision probability or a higher missed cleaning probability corresponds to a smaller number of point clouds in a dense region, a larger size of the accessible space, a lower priority of passing through a dense region, and a smaller cleaning coverage of dense regions; and
cleaning the target region based on the cleaning parameter.

9. The method according to claim 1, further comprising:
intelligently identifying a current scene of the target region, and matching the corresponding cleaning parameter based on a scene identification result and in combination with at least one of the collision probability or missed cleaning probability, to execute cleaning on the target region.

10. The method according to claim 1, further comprising at least one of:
receiving a designation instruction, provided by the user based on a pre-built map, for the target region; or
determining, by means of intelligent identification, whether the autonomous moving device enters the target region, and if so, determining to execute the step of executing cleaning on the target region based on at least one of the collision probability or missed cleaning probability.

11. The method according to claim 1, further comprising:
reading a historical cleaning log of at least part of the target region; and
automatically adjusting at least one of the cleaning and obstacle avoidance mode or cleaning and obstacle avoidance parameter based on the historical cleaning log.

12. The method according to claim 11, wherein automatically adjusting at least one of the cleaning and obstacle avoidance mode or cleaning and obstacle avoidance parameter based on the historical cleaning log comprises:
in response to determining based on the historical cleaning log that a number of collisions with any obstacle is greater than a preset first threshold, adjusting at least one of the cleaning obstacle avoidance mode or cleaning obstacle avoidance parameter to achieve a lower collision probability.

13. The method according to claim 11, further comprising:
in response to a current collision probability being less than a preset second threshold, not executing the step of adjusting at least one of the cleaning and obstacle avoidance mode or cleaning and obstacle avoidance parameter.

14. A method for controlling an autonomous moving device, comprising:
reading a historical cleaning log generated in a case that the autonomous moving device performs cleaning on at least part of a target region; and
automatically adjusting at least one of a cleaning and obstacle avoidance mode or a cleaning and obstacle avoidance parameter of the autonomous moving device based on the historical cleaning log, wherein at least one of the cleaning and obstacle avoidance mode or cleaning and obstacle avoidance parameter is default or determined based on a setting instruction from the user.

15. The method according to claim 14, wherein automatically adjusting at least one of the cleaning and obstacle avoidance mode or cleaning and obstacle avoidance parameter of the autonomous moving device based on the historical cleaning log comprises:
in response to determining based on the historical cleaning log that a number of collisions with any obstacle is greater than a preset first threshold, adjusting at least one of the cleaning obstacle avoidance mode or cleaning obstacle avoidance parameter to achieve a lower collision probability.

16. The method according to claim 14, further comprising:
in response to a current collision probability being less than a preset second threshold, not executing the step of adjusting at least one of the cleaning and obstacle avoidance mode or cleaning and obstacle avoidance parameter of the autonomous moving device.

17. A non-transitory computer-readable storage medium storing a computer program instruction therein, wherein the computer program instruction is loaded and executed by a processor to implement operations performed in the method according to claim 1.

18. A non-transitory computer-readable storage medium storing a computer program instruction therein, wherein the computer program instruction is loaded and executed by a processor to implement operations performed in the method according to claim 14.

19. An autonomous moving device, comprising a processor and a memory storing a computer program instruction executable by the processor, wherein the processor is configured to:
receive a setting instruction, provided by a user, for at least one of a cleaning and obstacle avoidance mode or cleaning and obstacle avoidance parameter;
determine at least one of a corresponding collision probability or a corresponding missed cleaning probability based on the setting instruction; and
execute cleaning on a target region based on at least one of the collision probability or missed cleaning probability.

20. An autonomous moving device, comprising a processor and a memory storing a computer program instruction executable by the processor, wherein the processor, when executing the computer program instruction, implements the method according to claim 14.
